(19) United States
(12) Patent Application Publication
(10) Pub. No.: US 2009/0090022 A1
(43) Pub. Date: Apr. 9, 2009

(54) Desiccation Chamber and Methods for Drying Biological Materials

(75) Inventors: David H. HO, McLean, VA (US); Stephen P. BRUTTIG, Murdock, NE (US)

Correspondence Address: Pepper Hamilton LLP, 400 Berwyn Park, 899 Cassatt Road, Berwyn, PA, 19312-1183, US

(73) Assignee: HEMEMICS BIOTECHNOLOGIES, INC., San Jose, CA (US)

(21) Appl. No.: 12/246,951

(22) Filed: Oct. 7, 2008

Related U.S. Application Data
(60) Provisional application No. 60/978,570, filed on Oct. 9, 2007.

(51) Int. Cl. F26B 3/04; F26B 9/08; F26B 21/00; F26B 25/04; F26B 25/06

(52) U.S. Cl. 34/406; 34/219; 34/216; 34/185; 34/187; 34/557; 34/559; 34/410; 34/474; 34/476; 34/498

(57) ABSTRACT

Methods and devices of drying biological materials are described, including a desiccation chamber that may be used to dry biological materials while substantially preserving functional integrity of those materials. The desiccation devices and methods provide optimal conditions and ease of use for drying biological materials. The devices and methods provided here may be used to prepare biological materials for use in one or more of diagnostic, therapeutic, industrial, and research applications.

### CROSS-REFERENCE TO RELATED APPLICATIONS

This application claims priority to U.S. provisional application Ser. No. 60/978,570 filed Oct. 9, 2007, which is incorporated herein by reference in its entirety.

### TECHNOLOGY FIELD

The present invention is directed, in part, to devices and methods for drying biological materials. More particularly, the invention relates to desiccation devices and processes to dry biological materials in order to extend the life of perishable biological materials.

### BACKGROUND

Storage and preservation of biological materials is crucial for the success of many applications involving biological materials. A variety of tools and methods have been used to achieve the storage and preservation of the biological materials. Drying/desiccation/dehydration is one of the tools and methods available for storage and preservation of biological materials.

Drying biological materials can serve various purposes within sectors ranging from small-scale academic research to large-scale commercial and industrial applications. Drying technologies seek to remove moisture from biologically active materials to stabilize them and store them for long-term future use. Current drying technologies employ drying devices, drying methods, and/or combinations of the two. Some examples of these drying technologies include freeze-drying, air drying, drying with microwaves, drying at sublimation phase, and drying at various temperature conditions.

Some methods for maintaining biological materials whether cell-based, macromolecules (examples may include, for example, DNA, proteins, carbohydrates and lipids), combinations such as blood and blood products (examples may include, for example, blood cells, macromolecules, carbohydrates and salts), or tissues and organs (examples may include, for example, the vasculature bed containing endothelial cells, smooth muscle cells, and combination of other cell types), utilize special storage media requiring refrigeration, liquid nitrogen storage, or a highly specialized buffer solution. These media typically are used in a short period of time to prevent spoilage due to the natural process of degradation and risks of pathogen contamination. Some other methods involve lyophilization and/or freeze-drying, and may allow for extended storage of dried biological materials. Some of these methods use chemicals such as dimethyl sulfoxide (DMSO), carbohydrates, paraformaldehyde and the like to fix biological materials during the lyophilization process. These chemicals often modify the biological materials and compromise their functions. Some other methods use sugars to stabilize biological materials prior to freeze-drying. These types of processes, however, may produce ice crystals and damaged biological materials structures.

A number of patents and patent applications report methods of drying biological materials for long term storage using desiccation or lyophilization processes, including: U.S. Pat. No. 5,398,426; U.S. Pat. No. 5,948,144; U.S. Pat. No. 6,057,101; U.S. Pat. No. 6,099,620; U.S. Pat. No. 6,225,611; U.S. Pat. No. 6,841,168; and PCT Publication WO/2006/127472. These conventional methods and devices often either damage the biological material as a result of chemical interference and/or ice crystal formation or, in many cases, are not easily adaptable for many applications. In one study involving various freezing protocols for hepatocyte suspensions, the authors observed low recovery and severe loss of functions (Koebe et al., Chem. Biol. Interact., 1999, 121, 99-115). Similarly, another study showed that a mechanical interaction between ice crystals and red blood cell membrane induced mechanical damage to the membrane (Ishiguro et al., Cryobiology, 1994, 31, 483-500).

Other processes of desiccation attempt to remove water at temperatures above the temperature which is inductive to ice crystal formation. Studies using this approach involved human embryonic kidney cells (Ma et al., Cryobiology, 2005, 51, 15-28), corneal epithelial cells (Matsuo, Br. J. Ophthalmol., 2001, 85, 610-612), mouse sperm cells (McGinnis et al., Biol. Reprod., 2005, 73, 627-33) and human mesenchymal stem cells (Gordon et al., Cryobiology, 2001, 43, 182-7) desiccated in the presence of trehalose. Another study involved desiccation of mouse spermatozoa (Bhowmick et al., Biol. Reprod., 2003, 68, 1779-86; McGinnis et al., Biol. Reprod., 2005, 73, 627-33; Meyers, Reprod. Fertil. Dev., 2006, 18, 1-5). Yet another study involving preservation of plasma membrane integrity after drying using traditional methods also provided variable results (Chen et al., Cryobiology, 2001, 43, 168-181). Despite some of these approaches showing promise in preservation of cells in the dried format while maintaining viability (Puhlev et al., Cryobiology, 2001, 42, 207-217), the results have been inconsistent and inconclusive. A reason for these inconclusive or inconsistent results with these new technologies could be the lack of proper devices or the lack of precision in currently available devices.

Thus, the field of drying biological materials suffers from a lack of drying devices and methodologies that can remove moisture from biological materials without causing damage to their structure or function. Such devices and methods are needed for therapeutic and diagnostic uses.

### SUMMARY

Embodiments of the present invention provide desiccation devices and processes for drying a biological material in a manner that preserves the structural and functional integrity of the biological material. Biological materials may be dried to a relatively low moisture content for extended periods of time while preserving functions upon reconstitution. The biological materials may be dried or dehydrated to a dry, or semi-dry, state while still preserving biological structure and function upon rehydration of the biological material.

Embodiments of the present invention provide for optimal conditions for drying or dehydration of biological materials. Embodiments of the present invention provide for ease of use during the drying or dehydration process.

According to one embodiment, a drying device for drying a biological material to a desired moisture content while preserving functional integrity of the biological material. The desiccation device may include one or more walls defining a desiccation chamber. An opening may be provided for placing a biological material into the desiccation chamber. An access door may selectively cover the opening. A support mechanism may be included in the desiccation chamber for supporting the biological material within the desiccation chamber. The support mechanism may include a shelf, rack, table, drawer, or the like. A weight sensing mechanism may also be provided in the desiccation chamber for sensing a weight of the biological material being dried in the desiccation chamber. The weight sensing mechanism may include, for example, a scale. The desiccation device may include a temperature control mechanism for regulating the temperature in the desiccation chamber. The temperature control mechanism may include a heater operatively coupled to the desiccation chamber and a temperature sensor in the desiccation chamber for sensing a temperature in the desiccation chamber. The desiccation device may also include a humidity control mechanism for regulating a moisture level within the desiccation chamber. The humidity control mechanism may include a humidity sensor for sensing a moisture level in the desiccation chamber.

According to another aspect of the invention, the desiccation device comprises a desiccation chamber having walls. The walls of the desiccation chamber may be constructed of one or more materials. The wall of the desiccation chamber may be made of materials that are not corrosive to heat, humidity, and/or biological materials. The walls of the desiccation chamber may also comprise an insulation material that can minimize heat loss and maintain thermal stability.

According to another aspect of the invention, the desiccation device may have at least one opening for placing biological material into the desiccation chamber and removing biological materials from the desiccation chamber. The desiccation chamber may also have at least two openings; one for placing the biological material into the desiccation chamber and one for removing the biological material from the desiccation chamber.

According to another embodiment, the drying device may include a gas control mechanism operatively coupled to the desiccation chamber for regulating a level of gas in the desiccation chamber. The gas control mechanism may fill the desiccation chamber with an inert gas, such as nitrogen. The gas control mechanism may maintain the desiccation chamber under gaseous saturation (e.g., approaching or at 100% nitrogen).

According to another aspect of the invention, the gas control mechanism may include a gas inlet and inlet valve for controlling a flow of gas into the desiccation chamber. The gas control mechanism may also include a gas outlet and outlet valve for controlling a flow of gas out of the desiccation chamber. The gas outlet and outlet valve may be operatively coupled to a vacuum source for creating a sub-atmospheric condition within the desiccation chamber.

According to another aspect of the invention, the desiccation device may include a sensor for monitoring the moisture level in the biological material.

According to another embodiment, the drying device of claim 1, further comprising a contamination control mechanism operatively coupled to the desiccation chamber. The contamination control mechanism may include a device to generate ultra-violet light or gamma radiation to reduce and/or eliminate pathogen and/or contaminants.

According to another embodiment, the drying device may include a motion mechanism disposed within the desiccation chamber for moving the biological material within the desiccation chamber. The motion mechanism may help ensure thorough mixing and equal exposure of the biological material to drying. The motion mechanism may include one of: a turn table, a shaking device, an orbital shaker device, a vibrating device, a rocker device, or a motion device.

According to another aspect of the invention, the temperature control mechanism further includes an air circulating device operatively coupled to the desiccation chamber. The air circulating device may be used to circulate an atmosphere within the desiccation chamber.

According to another aspect of the invention, the temperature control mechanism regulates a temperature in the desiccation chamber in a range of about 70 and about 105 degrees Fahrenheit.

According to another aspect of the invention, the humidity control mechanism regulates a humidity level in the desiccation chamber in a range of about 0% and about 5% relative humidity.

According to another aspect of the invention, the gas control mechanism regulates a gas level within the desiccation chamber by evacuating a gas from the desiccation chamber to create a sub-atmospheric condition within the desiccation chamber. For example, a vacuum may be provided to create a sub-atmospheric condition within the desiccation chamber.

According to another aspect of the invention, the gas control mechanism regulates a gas level within the desiccation chamber by introducing an inert gas into the desiccation chamber.

According to another embodiment, the drying device may include a control module for controlling one or more of: the temperature control mechanism, the humidity control mechanism, the gas regulating mechanism, the contaminant control mechanism, the weight sensing mechanism, and/or the motion mechanism. The weight sensing mechanism may be operatively coupled to the support mechanism and may measures a change in weight of the biological material disposed on the support mechanism during the drying process. The control module, using a computing device and appropriate software, may determine a moisture content of the biological material based upon a change in weight of the biological material.

According to another embodiment, the drying device may include a computing device for controlling the drying device.

According to another embodiment, the drying device may include a seal between the opening and the access door of the desiccation device. The seal may form an airtight, or substantially airtight, seal between the opening and the access door. The one or more walls may include a double wall construction having an inner wall and an outer wall. Insulation may be disposed between the inner wall and the outer wall. The insulated double wall construction may help maintain a stable temperature within the desiccation chamber.

According to another embodiment, a drying or dehydrating device is provided for drying a biological material. The desiccation device includes a desiccation chamber. A support mechanism may be located in the desiccation chamber for supporting the biological material within the desiccation chamber. A weight sensing mechanism may be provided in the desiccation chamber for sensing a weight of the biological material being dried in the desiccation chamber. A temperature control mechanism may be used to regulate the temperature in the desiccation chamber. The temperature control mechanism may include a heater operatively coupled to the desiccation chamber and a temperature sensor for sensing a temperature in the desiccation chamber. A humidity control mechanism may be used to regulate a moisture level within the desiccation chamber. The humidity control mechanism may include a humidity sensor for sensing a moisture level in the desiccation chamber. The desiccation device may also include a gas control mechanism operatively coupled to the desiccation chamber. The gas control mechanism may be used to regulate a level of inert gas in the desiccation chamber.

According to another embodiment, a contamination control mechanism may be operatively coupled to the desiccation chamber. The contamination control mechanism may be used to regulate contaminants and/or pathogens in the desiccation chamber.

According to another embodiment, a computing device may be operatively coupled to the desiccation device. The computing device may be to control one or more functions/conditions/parameters for the drying device.

According to another embodiment, a desiccation method is provided for drying a biological material. The method may include placing a biological material into a desiccation chamber of a desiccation device. The method may include supplying the desiccation chamber with an inert gas to a predetermined level. The method may include heating the inert gas and biological material in the desiccation chamber. The method may include regulating the temperature within the desiccation chamber to a predetermined range. The heating step may also involve regulating the temperature with gradual temperature changes throughout the desiccation process for preservation of the biological material's function. The method may include regulating the humidity within the desiccation chamber to a predetermined range. The method may include measuring a weight of the biological material being dried in the desiccation chamber. The method may also include removing the dried biologic material from the desiccation chamber once the biological material is dried to a predetermined level of dryness. The predetermined level may be a dried or semi-dried state for the particular biological material or materials being dried. The process may conclude upon satisfactory completion of one or more of the above steps following introduction of biological material into the desiccation chamber wherein the dried biologic material may be removed from the desiccation chamber once the biological material is dried to a desired level of dryness.

The supplying gas into the desiccation chamber may involve maintaining a concentration of the gas throughout the desiccation process. Additionally, maintaining the gas concentration within the desiccation chamber may involve supplying the gas into the desiccation chamber and withdrawing the gas that carries moisture from the desiccation chamber at various times throughout the desiccation process.

According to another embodiment, the method may further include reducing contamination of the biological material to a predetermined level to inactivate potential pathogens.

According to another embodiment, the method may include measuring a change in weight of the biological material during the drying process. The method may then provide for determining a moisture content of the biological material based upon a change in weight of the biological material.

According to another embodiment, the method may include exposing the biological material to substantially equal drying during the desiccation process. This may be accomplished by moving the biological material about within the desiccation chamber using a motion mechanism. The process of moving the biological material may result in mixing the biological material.

According to another aspect of the invention, supplying an inert gas to a predetermined level further includes supplying nitrogen approaching and approximating 100%.

According to another aspect of the invention, regulating the temperature to a predetermined level further includes regulating the temperature between about 70 and about 105 degrees Fahrenheit.

According to another aspect of the invention, regulating the humidity within a predetermined range further includes regulating the humidity between about 0% and about 5% relative humidity.

According to another aspect of the invention, removing the biological material at a predetermined level of dryness includes removing the biological material when the biological material is in a dry state.

According to another aspect of the invention, removing the biological material at a predetermined level of dryness includes removing the biological material when the biological material is in a semi-dry state.

According to another embodiment, the method may include controlling one or more functions of the operation of the desiccation device using a control module and microprocessor.

According to another aspect of the invention, the process may involve setting temperature and humidity (as well as other conditions) inside the desiccation chamber to predetermined levels prior to placing the biological material into the desiccation chamber.

Additional features and advantages of the invention will be made apparent from the following detailed description of illustrative embodiments that proceed with reference to the accompanying drawings.

### BRIEF DESCRIPTION OF THE DRAWINGS

The foregoing and other aspects of the present invention will become apparent from the following detailed description of the invention when considered in conjunction with the accompanying drawings. For the purpose of illustrating the invention, there is shown in the drawings embodiments that are presently preferred, it being understood, however, that the invention is not limited to the specific instrumentalities disclosed. In the drawings:

FIG. 1 shows a schematic top view of a drying device according to one embodiment of the invention;

FIG. 2 shows a schematic front view of a drying device according to one embodiment of the invention;

FIG. 3 shows a schematic front view of a drying device according to one embodiment of the invention;

FIG. 4 shows a schematic view of an exemplary control module and computing device of a drying device according to one embodiment of the invention;

FIG. 5 shows a flow chart detailing an exemplary drying process using a drying device; and

FIG. 6 shows a flow chart detailing an embodiment of a drying process using a drying device.

### DETAILED DESCRIPTION OF EMBODIMENTS

The present invention relates to devices and methods for drying biological materials. One or more of the devices and methods may allow biological materials to be dried to a low moisture content for long-term or extended storage while preserving functions of the biological materials upon reconstitution. The devices and methods of the present invention allow for optimal preservation of biological materials in a dry, or semi-dry, state while still preserving biological structure and function upon rehydration of the biological material. Various embodiments of the present invention may be used either with a single biological material or multiple biological materials individually or in combination, in a dry format for extended storage.

As used herein, the phrase “biological material(s)” refers to cells and/or to macromolecules.

As used herein, the term “cell” means nucleated cells (i.e., cells containing one or more nuclei) or anucleated cells (i.e., platelets and red blood cells; cells that have no nucleus). Cells may be in the form of individual cells, tissue(s), and/or organ(s). Cells can be derived from any organ. Different cells can be present in the same sample being desiccated. In addition, cells can be altered by humans such as, for example, cell lines and hybridomas. Cells include animal cells and/or plant cells. Animal cells include, but are not limited to, blood cells, cells derived from organs such as hepatocytes, smooth muscle cells, endothelial cells, keratinocytes, islet cells, stem cells (adult and neonatal, various tissues, or species origin), stem cell progenitor cells, cord blood cells, gametes (male and female), gamete progenitor cells, erythroblasts, leukoblasts, and chondroblasts. Blood cells include, but are not limited to, nucleated cells (such as white blood cells, including T cells and B cells), and anucleated cells (such as platelets, red blood cells, and the like). Cells also include cell lines and hybridomas.

The aforementioned cells can serve the agriculture, forestry, human, and the veterinary market. Furthermore, one or more of the embodiments of the present invention may be designed and adapted for various uses such as academic research, commercial research, or industrial applications.

As used herein, the term “macromolecule” means any protein, nucleic acid, carbohydrate, lipid, or other such molecule, produced or existing free in other body/biological fluids. Biomolecules can be present alone, or in combination with other biomolecules and/or cells, such as plasma products (i.e., blood cells, biomolecules, and salts), tissue, and/or organs, such as the vasculature bed containing endothelial cells, smooth muscle cells and some combination of other cell types. Biomolecules also include, for example, antibodies and peptides, or compositions of biomolecules such as, for example, the proteins, peptides, and other biological organic molecules in plasma.

Moisture content may be defined as residual moisture after drying. It may be determined as wet sample weight before drying minus the weight of the sample after drying. As used herein, the term “low moisture content” means less than about 25% residual moisture.

Dry and semi-dry are relative terms. They depend on user specifications for practicality. As used herein, the term “dry or a dry state” means less than about 25% residual moisture. As used herein, the term “semi-dry or a semi-dry state” means between about 25% and about 50% residual moistures.

As used herein, the term “long-term or extended storage” may be defined as weeks or months storage after desiccation.

Function may be defined based on what the protein, cell or tissue was capable of doing prior to desiccation. Minimally, it may be defined as that/those function(s) required by the user. Thus, an enzyme might function, for example, if it can catalyze the conversion of substrate to some end product, or a platelet, for example, might bind to collagen or initiate clot formation if function is preserved. In like manner, red blood cells used for reagents for blood typing might function, for example, if they are capable of reacting to typing antibodies in an antigen-specific manner. Biological function is equivalent to function. Biological structure for proteins may refer, for example, to maintaining the primary, secondary, tertiary and quaternary molecular structures intact. For cells, preserving biological structure may refer to keeping cellular structures intact; structures such as, for example, plasma membrane, nucleus, mitochondria, Golgi apparatus, endoplasmic reticulum, various cellular inclusion bodies, sarcoplasmic reticulum, etc. A perfectly functional cells for one user might have damaged biological structure for another user's biological function demands, and vice-versus, a cell having damaged biological structure may be perfectly functional cells for another user.

Embodiments of the biological material drying systems and methods may desiccate biological materials at optimal conditions to improve preservation of the biological materials for extended shelf life, ease of storage and transportation. The optimal desiccation conditions for improved drying of biological materials may include one or more of: control or regulation of temperature in the desiccation chamber; control or regulation of humidity levels in the desiccation chamber; control or regulation of gas levels within the desiccation chamber; control or regulation of contaminants within the desiccation chamber; movement of the biological material within the desiccation chamber. Preferably, the moisture content of the biological material may be determined without having to open the desiccation device or remove the biological material from the desiccation chamber during the desiccation process.

In some embodiments, control of temperature in the desiccation chamber may be regulated in a range of about 70 and about 105 degrees Fahrenheit. An optimal value may depend on the desired rate for drying or the desired functions of the protein or cell. For some applications, an optimal temperature range might be in the range of about 97 to about 100 degrees Fahrenheit.

In one embodiment, control of humidity levels in the desiccation chamber may be regulated in a range of about 0% and about 5% relative humidity. Optimal values may include those values below 5% relative humidity that are reasonably achievable.

In one embodiment, control of gas levels within the desiccation chamber may be regulated to provide oxygen (O₂) levels in a range of about 0% to about 5%. Optimal values may include oxygen levels near 0%. In one embodiment, gas levels within the desiccation chamber may be controlled by evacuating a gas from the desiccation chamber. In another embodiment, the gas levels within the desiccation chamber may be controlled by introducing a gas into the desiccation chamber. For example, such gas levels may be achieved by vacuum and nitrogen flushing the desiccation chamber. Nitrogen concentrations in air are normally 79%, so flushing with 100% nitrogen (N₂) may be reasonably innocuous. Other inert gases may be used, but nitrogen is an cost-effective gas for the purpose.

In another embodiment, control of contaminants within the desiccation chamber may be regulated in a range as low as reasonably possible. Preferably, contaminants are regulated to 0%, if possible.

In one embodiment, the biological material within the desiccation chamber may be moved (e.g., shook, rotated, slowly tilted, oscillated, etc.) to ensure optimal desiccation of all the biological material.

In one embodiment, the desiccation chamber is maintained at a sub-atmospheric pressure. In one embodiment, control of pressure in the desiccation chamber may be in a range of about 570 mmHg (or Torr) and about 585 mmHg (or Torr). Under such conditions, the desiccation device 10 acts as a vacuum oven to vacuum dry the biological material.

The optimal conditions for the desiccation process may be dependant on the particular biological material or materials being dried. Different biological materials may benefit from different desiccation conditions. Optimal preservation of biological materials may be achieved by regulating the desiccation conditions based on the biological material or materials being dried.

Embodiments of the desiccation systems and methods for drying biological materials may include features that provide for ease of use of the desiccation device. For example, one or more of the following features may be included to provide ease of use of the desiccation device: an inlet opening and access door; an outlet opening and access door; an air circulator or fan; a gas inlet valve, a gas outlet valve; a gas flow measuring mechanism; a support mechanism, such as a shelf, tray, drawer, table, etc.; a weight measuring mechanism, such as a scale; a temperature sensor; a humidity sensor; an oxygen sensor; a contaminant removal mechanism; a pathogen reduction mechanism; a control module, a display; safety devices, and the like. In one embodiment, the system provides for automated monitoring and control of one or more functions/conditions/parameters of the desiccation process. In one embodiment, the system provides for automated monitoring and control of all of the parameters of the desiccation process.

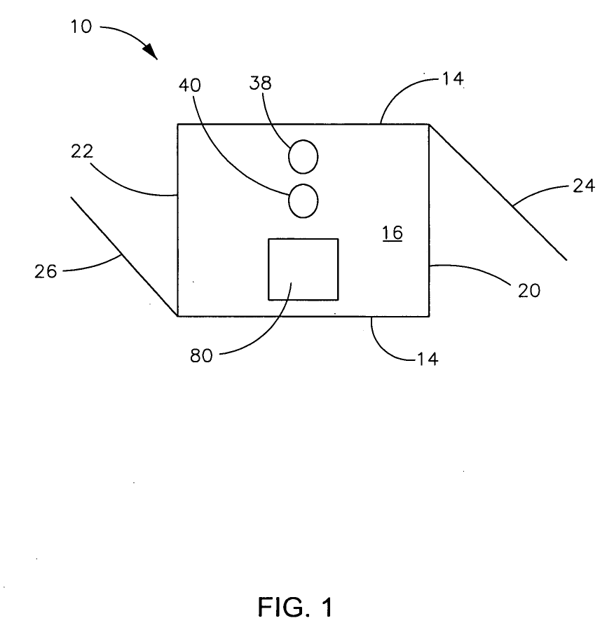

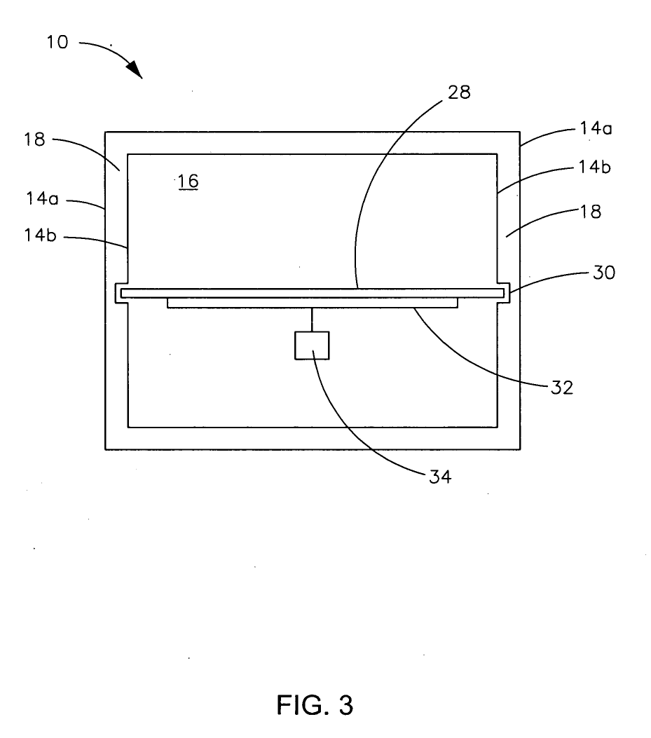

FIGS. 1-3 show an exemplary desiccation device 10 that may be used for dry preservation of biological materials 12. As shown, the desiccation device 10 may include one or more walls 14 defining a desiccation chamber 16. In one embodiment, the walls 14 of the desiccation device may help maintain thermal stability within desiccation chamber 16. For example, the desiccation device may have a double wall 14a, 14b construction for insulation, as depicted in FIG. 3. The double wall construction may include an air space or insulation material 18 between the double walls 14a, 14b. Although the insulating double wall represents one version of the design, the walls 14 of the device 10 may be designed in many other ways while maintaining optimal thermal stability without deviating from the scope of the present invention.

The walls 14 of the desiccation device 10 may be constructed of one or more materials. For example, the walls may be made of any suitable material such as plastics, thermoplastics, ceramics, metals, alloys, polymers, or combinations thereof. In addition, the walls of the desiccation chamber may be made of materials that are not corrosive in response to heat, humidity, and/or biological materials. For example, the walls may be composed of polycarbonate and similar materials to withstand thermal stress. Further, the walls of the desiccation device may also comprise an insulation material that can minimize heat loss and maintain thermal stability. Any insulating material that can maintain thermal stability may be used to provide additional thermal stability. For example, fiberglass may be used to maintain thermal stability. Temperature protection may help ensure that the desiccation chamber temperature will not damage stored material or the cabinet itself.

As shown, the desiccation device 10 may include one or more openings 20 or 22 for placing biological material 12 into the desiccation chamber 16 and removing biological material 12 from the desiccation chamber 16. In other embodiments, the desiccation device 10 may include multiple openings. For example, the desiccation device 10 may include a first opening 20 for placing the biological material 12 into the desiccation chamber 16, and a second opening 22 for removing the biological material 12 from the desiccation chamber 16.

In some embodiments, the desiccation device 10 may include one or more access doors 24 or 26. In other embodiments, the desiccation device 10 may include multiple access doors. For example, a first access door 24 and a second access door 26. For example, the first access door 24 to the desiccation chamber 16 may be used for loading biological material 12 for drying, and the second access door 26 to the desiccation chamber 16 may be used for removing the dried material 12 directly into packaging in an aseptic manner.

The access doors may be attached to the desiccation device 10, for example, by hinges (not shown) to provide access to the desiccation chamber 16. Other means of attaching the access doors 24, 26 to the desiccation device 10 may be employed to provide selective access to the desiccation chamber 16. The access doors may be constructed in any manner that would allow for introduction and removal of biological material in an aseptic manner.

Construction of the walls 12 and doors 24, 26 of the desiccation device 10 may be in such a way that they allow for maintaining sufficient vacuum capacity to reduce internal pressure to pre-determined levels (i.e., sub-atmospheric levels). For example, a sealing device may be provided where the openings 20, 22 and the access doors 24, 26 meet to form an airtight, or substantially airtight, seal between the opening and the access door. For example, a gasket, o-ring, piece of rubber material, and the like may be positioned where an access door meets the walls around a perimeter of an opening.

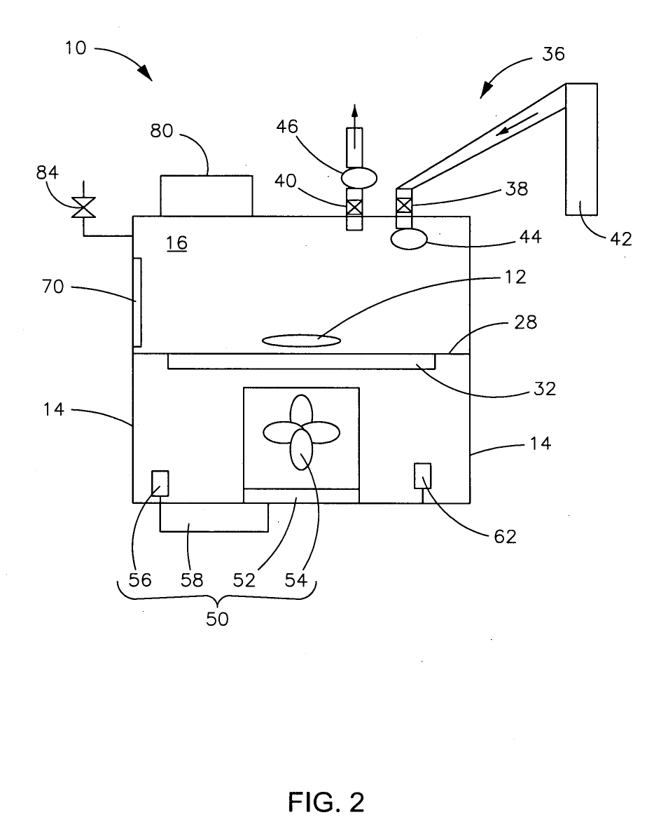

As shown in FIGS. 2 and 3, the exemplary desiccation device 10 may include a support mechanism 28 located within the desiccation chamber 16 for supporting a biological material 12. For example, the support mechanism 28 may include a shelf, rack, table, drawer, or the like. The desiccation chamber 16 may include multiple shelves, racks, tables, drawers, etc. and/or combinations thereof. As shown in the embodiment of FIG. 3, the support mechanism 28 for supporting the biological material may include a notch 30 in one or more side walls 14 to allow for a sliding shelf or drawer 28 for supporting a biological material 12. In another embodiment, the support mechanism 28 may include at least one shelf or at least one slide-out removable drawer to access space within the desiccation chamber 16. The support mechanism 28 may be designed to provide improved access to the desiccation chamber interior or storage space 16 and/or ease of removal of the biological materials 12.

The desiccation device 10 may also include a weight sensing mechanism 32 for sensing the weight of the biological material 12 being dried in the desiccation chamber 16. As depicted in FIGS. 2 and 3, for example, a weight sensing mechanism 32 may be incorporated into or used in conjunction with the support mechanism 28 to determine the weight of biological materials 12 placed on the support mechanism 28. The weight sensing mechanism 32 may be designed such that it provides accuracy in weight measurement as well as ease in use of the support mechanism 28. The weight sensing mechanism 32 may include, for example, a scale. Various types of scale may be used, such as a spring scale, hydraulic scale, a pneumatic scale, or the like. The weight sensing mechanism 32 may be a laboratory weighing machine such as those supplied by Mettler-Toledo, Inc. of Columbus, Ohio or Sartorius AG of Goettingen, Germany.

In addition, the desiccation device 10 may include a motion mechanism 34 for moving the biological materials within the interior space of the desiccation chamber 16 to ensure, for example, thorough mixing and/or equal exposure to drying. For example, the motion mechanism 34 may include a turn table, a shaking device, an orbital shaker device, a vibrating device, a motion device, and the like well known to the skilled artisan. The motion mechanism 34 may be designed to keep the biological material 12 in constant motion. The motion may include, for example, linear motion, rotary motion, intermittent motion, rocking motion, irregular motion, oscillation motion, reciprocating motion, etc.

The device may also have a gas control mechanism 36 for regulating a level of gas in the desiccation chamber 16. For example, the gas control mechanism 36 may include a gas supply mechanism for supplying an inert gas, such as nitrogen, to the desiccation chamber 16. Other inert gases that may be used include helium and argon. Inert gases may be used to drive out include oxygen (O₂) and carbon dioxide (CO₂) from the desiccation chamber 16. For example, the gas control mechanism 36 may include a gas removal mechanism for evacuating a gas from the desiccation chamber 16. Examples of gases that may be removed from the desiccation chamber 16 may include oxygen (O₂) and carbon dioxide (CO₂).

As depicted in FIGS. 1 and 2, the gas control mechanism 36 may include at least one inlet valve 38 for introduction of a gas into the desiccation chamber 16 and at least one outlet valve 40 for removal of gas from the desiccation chamber 16. A pressurized gas supply, a pump, a fan, or the like may be in fluid communication with the inlet valve 38 and may be used to supply a gas into the desiccation chamber 16. A pump, fan or the like (not shown) may be in fluid communication with the outlet valve 40 and may be used to evacuate a gas from the desiccation chamber 16, for example under vacuum. In some embodiments, the flow of gas through the desiccation device 10 may be controlled in such a way as to maintain the desiccation chamber 16 under gaseous saturation. The gas supply and/or the gas removal mechanisms may be linked to a computer/microprocessor controller, described in more detail below.

As depicted in FIG. 2, an inlet valve 38 may be attached to a supply of gas 42 external to the desiccation device 10. In some embodiments, the gas supply/removal mechanism 36 for supplying gas into the desiccation chamber 16 may comprise a self-contained gas generator that releases gas inside the desiccation chamber at a predetermined rate. A preferred concentration of inert gas (e.g., nitrogen) may be nominally 100%.

As depicted in FIG. 2, the inlet and outlet valves 38, 40 may be coupled to inlet and outlet measuring mechanisms 44, 46, respectively, to monitor and/or measure the flow of the gas into and out of the desiccation chamber 16. For example, the device 10 may be comprised of at least one gas flow inlet meter 44 measuring the flow of the gas entering the desiccation chamber 16 and/or at least one gas flow meter 46 measuring the flow of gas exiting the desiccation chamber 16. The gas flow meters 44 and/or 46 may be linked to a computer/microprocessor controller, described in more detail below.

As shown in FIG. 2, the desiccation device 10 may comprise a temperature control mechanism 50 for regulating temperature within the desiccation chamber 16. In some embodiments, the temperature control mechanism 50 for regulating temperature during the desiccation process may comprise a heating unit 52 for heating the atmosphere within the desiccation chamber 16. The heating unit 52 may be operably connected to the desiccation device 10. The unit for heating 52 may be located wholly or partially inside or outside the desiccation chamber 16.

In addition, the temperature control mechanism 50 may include an air circulating mechanism, such as a fan 54, which circulates air/gas through the desiccation chamber 16. In one embodiment, the fan 54 is located proximate the heater 52. In one embodiment, the fan 54 and heater 52 may be incorporated as an integral component. In some embodiments, the heating fan 54 may be oriented such that recirculation of gas within the desiccation chamber 16 may be optimized. For example, the heating fan 54 may be variable speed and multi-directional and may be controlled to change speed or direction to ensure heat or air/gas flow in possible “dead spaces” within the chamber 16. “Dead spaces” may be defined as spaces (corners, crevices, etc.) where air/gas flow is stagnant. Such dead spaces may be determined by the placement of pressure, flow or oxygen sensors throughout the desiccation chamber 16.

The temperature control mechanism 50 may also comprise a temperature measuring mechanism 56 for measuring the temperature inside the desiccation chamber 16. For example, the temperature measuring mechanism 56 may include a temperature sensor such as a thermometer.

The unit for heating 52 and the temperature measuring mechanism 56 may be operably connected by a feedback module 58 and may be automated to maintain the temperature inside the desiccation chamber 16 within a predetermined range. In some embodiments, the unit for heating 52 is a heating module that may be used to maintain the device's temperature up to about 180° F.

The heating module 52 may be used for longer exposure times at modestly elevated temperatures to reduce thermal shock and ensure more uniform subsurface drying. Drying cycle times may vary with, for example, volume of fluid to be evaporated and with evaporation rates. As an example, 5 ml of fluid, distributed in 10 aliquots (0.5 ml each) in a small chamber, may require 3 hours drying cycle time in order to reach the desired dryness without damaging the cells to be dried. The heating module may also reside partially outside of the desiccation chamber. The heating module may be any heating device commercially available or may be a device manufactured to suit a particular need or application. In addition, orientation of the heating module on the desiccation device may be such that the fan's function may be operational and optimized. An optimal configuration of the heating element, for example, may be near both the gas flow inlet and the fan.

In some embodiments, the desiccation device 10 may include a humidity control mechanism 60 for controlling or regulating the humidity level within the desiccation chamber 16. The humidity control mechanism 60 may comprise at least one humidity sensor 62 for monitoring and measuring the moisture level (humidity level) inside the desiccation chamber 16. The humidity control mechanism 60 may comprise at least one non-invasive sensor (not shown) for monitoring and measuring the moisture level in the biological material 12. The desiccation device 10 may also comprise a weight measuring mechanism 32 for measuring the weight of the biological material 12 to determine a moisture content of the biological material 12.

Humidity within the desiccation chamber 16 may be controlled, for example, by using a manual or automated gas control mechanism 36, which regulates the flow of dry process gas into the desiccation chamber 10. The positions of the inlet valve 38 and outlet valve 40, as depicted in FIGS. 1 and 2, represent one version of the design, but may be placed elsewhere such that gas flow may optimally saturate the desiccation chamber 16 while removing maximal moisture. In addition, the flow of gas into or out of the desiccation chamber 16 may be controlled not by partial opening or closing of the valves 38, 40, but by timing of complete opening or complete closure, such as with the use of solenoid valves (not shown).

Alternatively, relative humidity in the desiccation chamber 16 may be controlled by, for example, connecting to high efficiency fans, humidifying or dehumidifying equipment, and the like. For example, the unit for heating 52 and fan 54 may be used to help control humidity.

As shown in FIG. 2, the desiccation device 10 may also comprise a pathogen reduction/contaminant control mechanism 70 for inactivating, removing or reducing contamination, such as undesired biological organisms and/or biological materials. The contaminant control mechanism 70 for reducing contamination may comprise, for example, a device to generate ultra-violet light or gamma radiation. Reduction or removal of contaminants may also be accomplished by filtration of the inlet inert gas. The biological materials to be dried are preferably collected aseptically. The goal is to introduce no additional contamination and to decontaminate any surfaces within the desiccation device that may contribute to the contamination of the sample. All levels of contamination/pathogens should be as low as reasonably achievable. The contaminant control mechanism 70 for removing or reducing contamination depicted in FIG. 2 may be designed and oriented with the desiccation chamber such that sterilization and decontamination may be optimally achieved.

In some embodiments, the desiccation device 10 may include a control module 80. The control module 80 may control and regulate one or more of: temperature control mechanism 50; humidity control mechanism 60; gas regulating mechanism 36; contaminant control mechanism 70; weight sensing mechanism 32; and/or motion mechanism 34.

The control module 80 may also include a display 82 for displaying one or more conditions or parameters of the desiccation process. For example, the display 82 may provide an indication of desiccation chamber temperature, desiccation chamber humidity, desiccation chamber pressure, desiccation chamber gas level, desiccation chamber contaminant level, time of drying, weight of the biological material, moisture content of the biological material, etc.

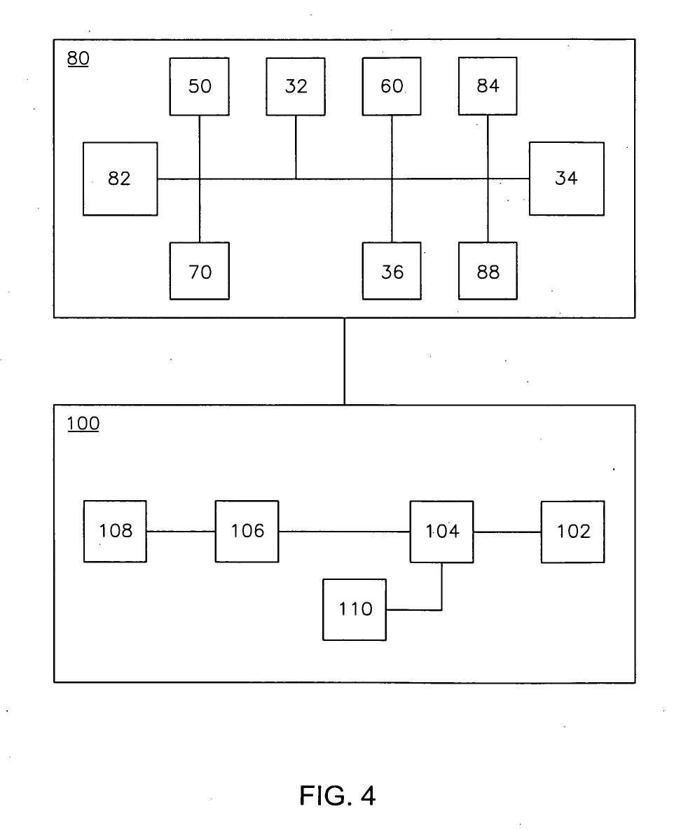

As shown in FIGS. 1 and 4, the desiccation chamber 10 may also include a safety relief or bleed valve 84 to maintain predetermined, and safe, pressure conditions within the desiccation chamber 16. The safety relief or bleed valve 84 may be controlled by the control module 80.

In some embodiments, the control module 80 may include an automated control module that may comprise at least one microprocessor or computing device 100. The microprocessor may be capable of being operated remotely. The control module 80 may also include a mechanism for determining sub-ambient humidity set points (not shown).

The microprocessor or computing device 100 may be part of the control module 80 or may be a separate component. As shown in FIG. 4, an exemplary computing device 100 may include input component 102, memory component 104, processing component 106, output component 108, and/or software program 110. Device 100 may be a special purpose computing device (i.e., limited to computing, monitoring, storing, etc. drying or dehydration functions/conditions/parameters). Computing device 100 may also be a general purpose computing device, such as a desktop personal computer (PC), a portable PC, a laptop, and the like.

Input component 102 may be any suitable hardware for entering drying-related information into computing device 100. For example, input component 102 may include a keypad, a keyboard, a touch screen, a scroll wheel, a speech recognition module, and the like.

Information that is entered via input component 102 may be stored in memory component 104, which may include random access memory (RAM), read only memory (ROM), and programmable read only memory (PROM), and the like. Memory component 104 may be physically integrated into computing device 100 and/or removably attached. In addition to storing information entered via input component 102, memory component 104 may also store executable software instructions, such as software program 110, which may be adapted to perform predetermined computing tasks.

For example, software program 110 may include executable software instructions for automatically computing optimal drying conditions for a particular biological material. Program 110 may be executed via processing component 106, which may be any suitable type of processor for performing arithmetic calculations. Information relating to the drying process may be provided to a user via output component 108, which may be a visual display, such as a liquid crystal display (LCD), or an audio output device, such as a speaker.

The control module 80, as depicted in FIG. 4, represents only one version and may be altered to comprise other functions. For example, some modifications may include: a control system for heating and dehumidification of the entire desiccation chamber or shelf-by-shelf control; a moisture analysis scale to constantly monitor the level of moisture content in the sample; and/or an orbital shaker to ensure thorough mixing and equal exposure to drying and sterilizing processes.

The display 82 for indicating one or more conditions of the desiccation process, such as sensed or measured temperature and/or sensed or measured humidity, may also show or indicate the status of other conditions or variables of the desiccation process. The automated control module 80 may be operably designed to relay data through electrical communication from the temperature, humidity, and/or weight measuring mechanisms. Communications and data sharing may be via wire or wireless communications.

In some embodiments, the desiccation device 10 may include a mechanism 88 for creating and/or maintaining sub-atmospheric pressure. In some embodiments, the sub-atmospheric pressure may be generated using a vacuum. For example, when biological material to be dried requires a sub-atmospheric pressure, a vacuum source 88 may be used to create the sub-atmospheric pressure within the interior space 16. The mechanism to create and maintain sub-atmospheric pressure 88 may be designed and oriented with the desiccation chamber 10 such that the sub-atmospheric pressure may be optimally reached and sustained. For example, vacuum pumps may be set or regulated manually, by timer or by microprocessor control. Such pumps may operate such that the desired level of vacuum (i.e., negative pressure) may be reached in a defined and optimal manner. Such manner may depend, for example, upon the biological material to be desiccated, the volume to be desiccated, and the level of desiccation required, all with the concern that biological function may be restored with rehydration.

In some embodiments, the desiccation device 10 may further comprise a shutdown mechanism (not shown) for safe and automatic shut-down when the device operates outside of temperature and pressure ranges designated by the desiccation device operator. The shutdown mechanism may be incorporated into control module 80.

The control of the desiccation device 10 or methods may be achieved manually by the operator or may be automated. Automation of the device and methods may include an automated control mechanism comprising controls, sensors, and any other part (e.g., effectors) alone or in combination that may be required for automation of the device and/or methods. The automation may also be through wireless mechanisms. The automated control mechanism may include parts made from materials such as electronics, mechanical parts, chemical formulations and/or any other types of parts alone or in combination to create a controllable system. The automated control mechanism may be employed in any combination for one or more device parts and/or one or more method steps. The automation may involve microprocessors, sensors, effectors, data transfers, controllers, and the like.

It is recognized that for optimal control to occur, both sensors and effectors may be required. An effector, as used above, is the action device that completes the control circuit. For example, if negative pressure becomes too great in the desiccation chamber, the vacuum pump may be slowed or the gas inlet valve may be opened, allowing inert gas to enter the chamber in order to reduce the negative pressure. In these examples, the vacuum pump or the gas inlet valve may be thought of as effectors.

For example, some embodiments may involve automated control of temperature wherein the automated control mechanism may set and maintain temperature within the desiccation chamber. Some embodiments may also include temperature sensors that can relay information about desiccation chamber temperature through a wireless means to a display, as well as operate through a feedback mechanism which may then alter temperature to maintain thermal stability.

Some embodiments may involve automated control of gas flow into the desiccation chamber 10 wherein an automated control could introduce gas into the desiccation chamber such that optimal concentrations of gas inside the desiccation chamber are achieved. Some embodiments may also include chemical sensors to measure the concentration of gas within the desiccation chamber. Combinations of automated controls may also be used. The automated controlling means may be designed in relation to the desiccation chamber such that automated control of the device and methods are optimally achieved. For example, in some embodiments, the automated control mechanism may be coupled to the control module.

The present invention also provides methods for drying a biological material while preserving biological structure and function. The methods may be used with both pre-processed and unprocessed biological materials. In one example, the methods include preparatory steps prior to drying of the biological material. For example, the biological material may be prepared in various ways and stabilized in various buffer solutions for the desiccation process. One example for preparation of biological materials is drying of anucleated or nucleated cells for the dehydration process. However, any process that can stabilize cells in solution may be used. One example of a buffer solution that may be used prior to drying is phosphate buffered saline (PBS).

The methods may also involve washing the biological material through a process of centrifugation at predetermined speeds and resuspension in buffer solutions. Examples of buffer solutions include, but are not limited to, PBS, HEPES, Tris-buffer, and the like. Centrifugation of the biological material may be performed at speeds such that washing may be achieved without damaging the material.

The methods may also involve stabilization of the biological material in a stabilization solution that may include a membrane-stabilizing, non-reducing sugar or the like (e.g., trehalose); a lysosomal membrane stabilizer or the like (e.g., methylprednisolone sodium succinate=Solu-Medrol); a membrane “fluidizer”, like a mild mixture of glycerol or the like with a minimal, and/or an effective amount of omega-3 fatty acid or the like (e.g., EPA or ALA). Additionally, extracellular polymeric substrates (EPS) such as neutral dextran, serum albumin or the like may be added to the biological material. Preparatory steps of the methods may also warrant controlling the pH to maintain biological balance and maintain desired biological activities.

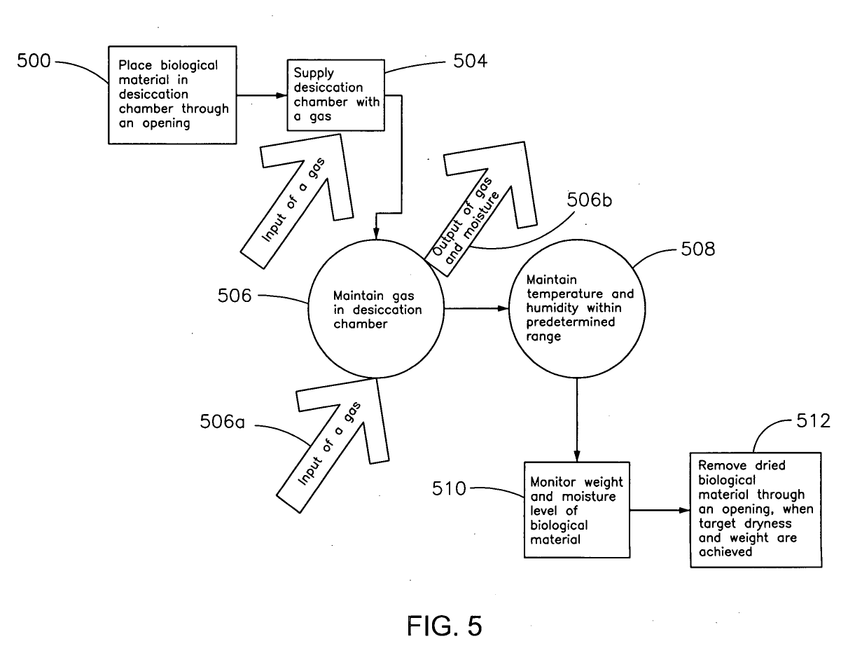

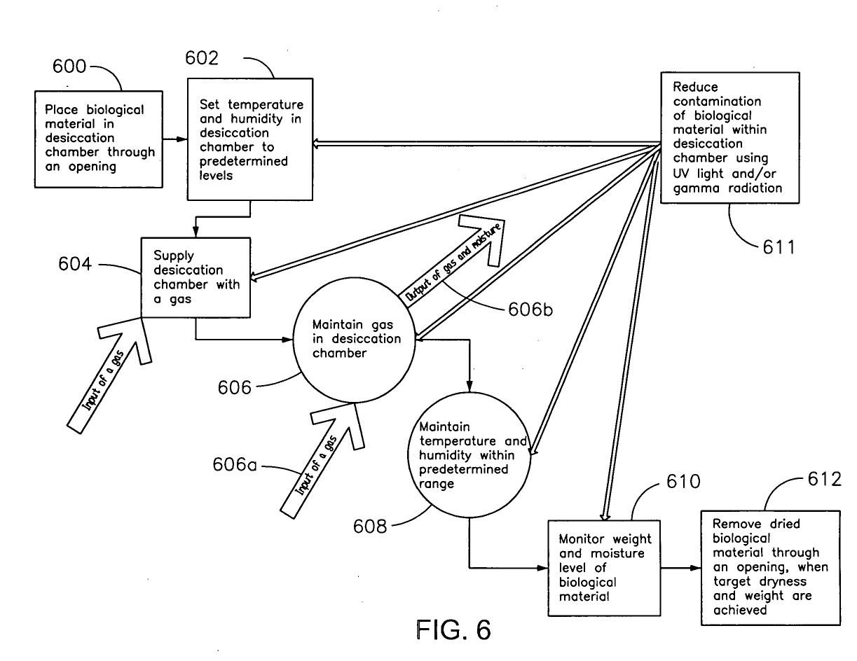

In some examples, prior to placing the biological material(s) in the desiccation chamber, the relative humidity and temperature of the desiccation chamber may be set to predetermined levels or ranges. The desiccation chamber may be saturated with a predetermined gas which may be maintained for the duration of the drying process. The flow of the predetermined gas may be continued and controlled through the drying process. FIGS. 5 and 6 depict exemplary embodiments of carrying out the methods described herein.

In some embodiments, the methods may be initiated by placing at least one biological material into a desiccation chamber of a dehydration device, Step 500/600. The method may involve setting the temperature and humidity inside the desiccation chamber to predetermined levels or ranges, Step 602, prior to placing the biological material into the desiccation chamber. The drying methods may involve using various methods to achieve the desirable level of dryness. One example of the drying methods involves using a desiccation or dehydration device described above.

In some embodiments, use of the drying device may involve using one or more of the functions described above in FIGS. 1-4. The drying methods using a desiccation device described above involve placing one or more biological materials into the desiccation chamber. In some examples, the biological material may be placed on a supporting means in the desiccation chamber. For example, to dehydrate a 50 ml sample, the supporting means can have a dimension of 7 cm×7 cm width and 1 cm depth. The supporting means, however, may be designed with dimensions and specifications such that drying of biological material may be achieved. Additionally, the tray can be made of any materials that allow for effective drying while preserving the biological material structure and function.

In some embodiments, the desiccation chamber may be supplied with a gas, Step 504/604. Supplying gas into the desiccation chamber may involve maintaining a concentration of the gas throughout the desiccation method, Step 506/606. Additionally, maintaining the gas concentration within the desiccation chamber may involve supplying the gas into the desiccation chamber, Step 506a/606a and withdrawing the gas that carries moisture from the desiccation chamber, Step 506b/606b at various times throughout the desiccation process.

In some embodiments, the desiccation methods may also include a step wherein the contents of the desiccation chamber are heated, part of Step 508/608. Heating may involve regulating the temperature within the desiccation chamber to a preset range, part of Step 508/608. Heating may also involve regulating the temperature with gradual temperature changes throughout the desiccation process for preservation of the biological material's function.

In some embodiments, during the drying methods, the weight of the biological materials may be monitored continuously or periodically to determine the level of moisture content, Step 510/610. For example, the control module may be used to determine a moisture content of the biological material based upon a change in weight of the biological material measured by the weight sensing mechanism. The methods may be used to achieve any desired moisture level. For example, the biological materials can be dried to a moisture content from about 95% to about 2.5%. The process of drying may be stopped or caused to be stopped at any point that the device operator deems dryness at a desired level. For example, the device operator can consider the drying process complete when the relative level of moisture is at 5% of the original moisture content.

Preferred levels of moisture (or level of dryness) will depend upon the biologic (peptide, protein, cell, fluid or tissue) and the degree of retained biological structure and function after desiccation and rehydration. Generally, biologics are desiccated to a dry or semi-dry condition in order to retain specific functions. Dry and semi-dry may be relative terms and may depend on user specifications for practicality. For example, a preferred dryness for blood platelets might be about 15% residual moisture, whereas for red blood cells, the preferred dryness might be about 25% residual moisture. Such different levels are required to maintain biological structure and function after drying and rehydration.

The methods may include achieving or maintaining an acceptable level of asepsis or sterility during drying by reduction of contamination of the biological material, Step 611. The reduction of contamination may be achieved by, for example, using ultra-violet lighting or gamma radiation within the desiccation chamber to inactivate potential pathogens. In some embodiments, after drying and decontamination are deemed sufficient, the biological materials may be removed from the desiccation chamber and packaged for use, Step 512/612.

The methods may conclude upon satisfactory completion of one or more of the above steps following introduction of biological material into the desiccation chamber wherein the dried biologic material may be removed from the desiccation chamber once the biological material is dried to a desired level of dryness.

The technology of the present invention may expand the use of biological materials in science, technology, and medicine in areas once deemed too difficult or impossible. The devices and processes for drying or dehydrating biological material offer extended shelf-life for the storage of biological materials. The desiccated, packaged, and shelf-stored biological materials offer a logistical advantage for greater distribution to more markets worldwide. To use, the end users simply add water or tailored fluid and the biological materials will come back to life and be ready for use. In addition, biological materials may be characterized and pre-packed for specific applications. As such, biological materials dehydrated in accordance with the augmented desiccation processes described herein may include pharmaceuticals and other cell-based systems to be transported and used virtually everywhere in the world without the need for special storage, handling, and transportation.

### EXAMPLE 1

### Enhanced Shelf-Life of Selected Cells in Dried or Desiccated Format Using Desiccation Device and Cell-Drying Process Describe Herein:

| | | Shelf-life in Desiccated |
|---|---|---|
| Cell Type | Shelf-life in solution | Format |
| Platelets | 5 days | >45 days |
| B-cells | 14 days | >30 days |
| Stem cells | 1 day | ~3 days |

### EXAMPLE 2

### Application of Dehydration Protocol to Dry Mammalian Cells:

| | Shelf-life in | | Shelf-life with | |
|---|---|---|---|---|
| | solution at | | Desiccation | |
| Cell Type | 4° C. or RT | | Process | Reconstitution |
| Platelets | 5 | days | >45 days | Normal size and |
| | | | | function |
| B-cells | 14 | days | >30 days | Size, viability |
| | | | | reasonable and |
| | | | | function being |
| | | | | optimized |
| Red Blood Cells | 45 | days | Data not avail. | Normal size and |
| | | | | biconcave disk |
| Endothelial Cells | 2-3 | days | Data not avail. | Normal size and |
| | | | | viability very good |

### EXAMPLE 3

### Profiles of Reconstituted Dried RBCs and Platelets:

| Parameters | Fresh RBC | Reconstituted RBC |
|---|---|---|
| RBC (M/mL) | 4.99 | 5.02 |
| HGB (g/dL) | 17.64 | 22.70 |
| HCT (%) | 44.27 | 46.83 |
| MCV (Fl) | 88.9 | 93.1 |
| MCH (pg) | 32.7 | 45.1 |
| MCHC (g/dL) | 36.8 | 48.5 |

| Parameters | Fresh Platelets | Reconstituted Platelets |
|---|---|---|
| PLT (K/μL) | 1413 | 1116 |
| MPV (fL) | 17.64 | 8.33 |
| PDW (%) | 44.27 | 18.2 |
| PCT (%) | 88.9 | 0.93 |

### Preservation of Platelet Surface Markers:

| | | | Reconstituted |
|---|---|---|---|
| Markers | Fresh Platelets | Reconstituted PRP | Platelets |
| GP lb | X | X | X |
| GP llb/llla | X | X | X |
| Active GPllb/llla | X | X | X |
| P-Selectin | X | X | X |

In the foregoing description, various features are grouped together in a single embodiment for the purpose of streamlining the disclosure. This method of disclosure is not to be interpreted as reflecting an intention that the claimed embodiments of the invention require more features than are expressly recited in each claim. Rather, inventive subject matter lies in less than all features of a single disclosed embodiment.

It will be readily understood to those skilled in the art that various other changes in the details, material, and arrangements of the parts and method stages which have been described and illustrated to explain the nature of the present invention, may be made without departing from the principles and scope of the invention as expressed in the claims. Various modifications of the invention, in addition to those described herein, will be apparent to those skilled in the art from the foregoing description. Such modifications are also intended to fall within the scope of the appended claims.

What is claimed is:

1. A drying device for drying a biological material to a desired moisture content while preserving functional integrity of the biological material, comprising:
one or more walls defining a desiccation chamber;
an opening for placing a biological material into the desiccation chamber;
an access door proximate the opening for selectively covering the opening;
a support mechanism in the desiccation chamber for supporting the biological material within the desiccation chamber;
a weight sensing mechanism in the desiccation chamber for sensing a weight of the biological material being dried in the desiccation chamber;
a temperature control mechanism for regulating the temperature in the desiccation chamber, the temperature control mechanism comprising a heater operatively coupled to the desiccation chamber, and a temperature sensor in the desiccation chamber for sensing a temperature in the desiccation chamber; and
a humidity control mechanism for regulating a moisture level within the desiccation chamber, the humidity control mechanism comprising a humidity sensor for sensing a moisture level in the desiccation chamber.

2. The drying device of claim 1, further comprising a gas control mechanism operatively coupled to the desiccation chamber for regulating a level of gas in the desiccation chamber.

3. The drying device of claim 2, wherein the desiccation chamber may be filled with an inert gas, and the gas control mechanism maintains the desiccation chamber under gaseous saturation.

4. The drying device of claim 2, wherein the gas control mechanism further comprises:
a gas inlet and inlet valve for controlling a flow of gas into the desiccation chamber; and
a gas outlet and outlet valve for controlling a flow of gas out of the desiccation chamber.

5. The drying device of claim 4, wherein the gas outlet and outlet valve are operatively coupled to a vacuum source for creating a sub-atmospheric condition within the desiccation chamber.

6. The drying device of claim 1, further comprising a contamination control mechanism operatively coupled to the desiccation chamber.

7. The drying device of claim 6, wherein the contamination control mechanism further comprises a device to generate ultra-violet light or gamma radiation.

8. The drying device of claim 1, further comprising a motion mechanism disposed within the desiccation chamber for moving the biological material within the desiccation chamber to ensure thorough mixing and equal exposure of the biological material to drying.

9. The drying device of claim 8, wherein the motion mechanism further comprises one of: a turn table, a shaking device, an orbital shaker device, a vibrating device, a rocker device, or a motion device.

10. The drying device of claim 1, wherein the temperature control mechanism further comprises an air circulating device operatively coupled to the desiccation chamber for circulating an atmosphere within the desiccation chamber.

11. The drying device of claim 1, wherein the temperature control mechanism regulates a temperature in the desiccation chamber in a range of about 70 and about 105 degrees Fahrenheit.

12. The drying device of claim 1, wherein the humidity control mechanism regulates a humidity level in the desiccation chamber in a range of about 0% and about 5% relative humidity.

13. The drying device of claim 1, wherein the gas control mechanism regulates a gas level within the desiccation chamber by evacuating a gas from the desiccation chamber to create a sub-atmospheric condition within the desiccation chamber.

14. The drying device of claim 1, wherein the gas control mechanism regulates a gas level within the desiccation chamber by introducing an inert gas into the desiccation chamber.

15. The drying device of claim 1, further comprising a control module for controlling one or more of: the temperature control mechanism, the humidity control mechanism, the gas regulating mechanism, the contaminant control mechanism, the weight sensing mechanism, and/or the motion mechanism.

16. The drying device of claim 15, wherein the weight sensing mechanism is operatively coupled to the support mechanism, wherein the weight sensing mechanism measures a change in weight of the biological material disposed on the support mechanism during the drying process, and the control module determines a moisture content of the biological material based upon a change in weight of the biological material.

17. The drying device of claim 1, further comprising:
a seal between the opening and the access door of the desiccation device for forming an airtight, or substantially airtight, seal between the opening and the access door;
wherein the one or more walls comprise a double wall construction having an inner wall and an outer wall; and
insulation disposed between the inner wall and the outer wall, the insulated double wall construction maintaining a stable temperature within the desiccation chamber.

18. The drying device of claim 1, further comprising a computing device for controlling the drying device.

19. A desiccation method for drying a biological material comprising:
placing a biological material into a desiccation chamber of a desiccation device;
supplying the desiccation chamber with an inert gas to a predetermined level;
heating the inert gas and biological material in the desiccation chamber;
regulating the temperature within the desiccation chamber to a predetermined range;
regulating the humidity within the desiccation chamber to a predetermined range;
measuring a weight of the biological material being dried in the desiccation chamber;
removing the dried biologic material from the desiccation chamber once the biological material is dried to a predetermined level of dryness.

20. The method of claim 19, further comprising reducing contamination of the biological material to a predetermined level to inactivate potential pathogens.

21. The method of claim 19, further comprising:
measuring a change in weight of the biological material during the drying process; and
determining a moisture content of the biological material based upon a change in weight of the biological material.

22. The method of claim 19, further comprising exposing the biological material to substantially equal drying during the desiccation process by:
moving the biological material about within the desiccation chamber using a motion mechanism; and
mixing the biological material through the movement of the biological material.

23. The method of claim 19, wherein supplying an inert gas to a predetermined level further comprises supplying nitrogen approaching and approximating 100%.

24. The method of claim 19, wherein regulating the temperature to a predetermined level further comprises regulating the temperature between about 70 and about 105 degrees Fahrenheit.

25. The method of claim 19, wherein regulating the humidity within a predetermined range further comprises regulating the humidity between about 0% and about 5% relative humidity.

26. The method of claim 19, wherein removing the biological material at a predetermined level of dryness further comprises removing the biological material when the biological material is in a dry state.

27. The method of claim 19, wherein removing the biological material at a predetermined level of dryness further comprises removing the biological material when the biological material is in a semi-dry state.

28. The method of claim 19, further comprising controlling one or more functions of the operation of the desiccation device using a control module and microprocessor.

29. A drying device for drying a biological material comprising:
a desiccation chamber;
a support mechanism in the desiccation chamber for supporting the biological material within the desiccation chamber;
a weight sensing mechanism in the desiccation chamber for sensing a weight of the biological material being dried in the desiccation chamber;
a temperature control mechanism for regulating the temperature in the desiccation chamber, the temperature control mechanism comprising a heater operatively coupled to the desiccation chamber, and a temperature sensor for sensing a temperature in the desiccation chamber;
a humidity control mechanism for regulating a moisture level within the desiccation chamber, the humidity control mechanism comprising a humidity sensor for sensing a moisture level in the desiccation chamber; and
a gas control mechanism operatively coupled to the desiccation chamber for regulating a level of inert gas in the desiccation chamber.

30. The drying device of claim 29, further comprising a contamination control mechanism operatively coupled to the desiccation chamber, the contamination control mechanism regulating contaminants in the desiccation chamber.

31. The drying device of claim 29, further comprising a computing device for controlling one or more functions/conditions/parameters for the drying device.
